(19) United States
(12) Patent Application Publication
(10) Pub. No.: US 2024/0322846 A1
(43) Pub. Date: Sep. 26, 2024

(54) WIRELESS COMMUNICATION DEVICE

(71) Applicant: BUFFALO INC., Nagoya-shi (JP)

(72) Inventors: Shuhei YAMAGUCHI, Aichi (JP); Hirotaka NARUSE, Aichi (JP)

(73) Assignee: BUFFALO INC., Nagoya-shi (JP)

(21) Appl. No.: 18/609,159

(22) Filed: Mar. 19, 2024

(30) Foreign Application Priority Data
Mar. 22, 2023 (JP) 2023-046038

(51) Int. Cl. H04B 1/00

(52) U.S. Cl. CPC H04B 1/0064

(57) ABSTRACT

A wireless communication device includes: signal processing circuits configured to generate or demodulate wireless signals in a first frequency band and a second frequency band, wherein the first frequency band is different than the second frequency band; first and second signal processing module circuits communicably coupled to the signal processing circuits, the first and second signal processing module circuits configured to respectively process the wireless signals in the first frequency band and the second frequency band generated or demodulated by the signal processing circuits; and a switch module circuit configured to selectively connect the signal processing circuits with any one of the first and second signal processing module circuits.

### CROSS-REFERENCE TO RELATED APPLICATION

This application is based on and claims priority under 35 USC 119 from Japanese Patent Application No. 2023-046038 filed on Mar. 22, 2023, the contents of which are incorporated herein by reference.

### TECHNICAL FIELD

The present disclosure relates to a wireless communication device.

### BACKGROUND

As a multi-input-multi-output (MIMO) wireless system, Japanese Patent Application Laid-Open Publication No. 2009-219023 (hereinafter, referred to as Patent Literature 1) discloses a wireless system including a filter and an amplifier corresponding to a plurality of frequency bands, a band switching circuit, a signal terminal for inputting and outputting a signal in which a high frequency signal and a control signal are superimposed, and an inductor and a capacitor for separating the high-frequency signal and control signal from the signal input and output by the signal terminal. In the example of Patent Literature 1, any one of the plurality of frequency bands is selected and communication is performed.

However, for example, in a wireless local area network (LAN), there are client devices corresponding to a plurality of different frequency bands. For this reason, a wireless LAN device is generally set as to corresponding to communication in which frequency band by a client device possessed by a user.

In this case, it would be good to provide circuit units each corresponding to each of the plurality of frequency bands in which communication may be performed. However, this configuration has a problem in that the device cost increases.

According to the present disclosure, it is possible to provide a wireless communication device that can suppress an increase in device cost while corresponding to wireless communication in multiple frequency bands.

### SUMMARY

One aspect of the present disclosure relates to a wireless communication device including: signal processing circuits configured to generate or demodulate wireless signals in a first frequency band and a second frequency band, wherein the first frequency band is different than the second frequency band; first and second signal processing module circuits communicably coupled to the signal processing circuits, the first and second signal processing module circuits configured to respectively process the wireless signals in the first frequency band and the second frequency band generated or demodulated by the signal processing circuits; and a switch module circuit configured to selectively connect the signal processing circuits with any one of the first and second signal processing module circuits.

### BRIEF DESCRIPTION OF THE DRAWINGS

Exemplary embodiments of the present disclosure will be described in detail based on the following figures, wherein:

FIG. 1 is a block diagram showing a configuration example of a wireless communication device according to an embodiment of the present disclosure;

FIG. 2A is a block diagram showing a configuration example of a signal processing module of the wireless communication device according to the embodiment of the present disclosure;

FIG. 2B is a block diagram showing a configuration example of a signal processing module of the wireless communication device according to the embodiment of the present disclosure;

FIG. 3 is a flowchart showing an operation example of a controller of the wireless communication device according to the embodiment of the present disclosure;

FIG. 4 is a block diagram showing another configuration example of the wireless communication device according to the embodiment of the present disclosure; and

FIG. 5 is a block diagram showing a configuration example of another signal processing module of the wireless communication device according to the embodiment of the present disclosure.

### DESCRIPTION OF EMBODIMENTS

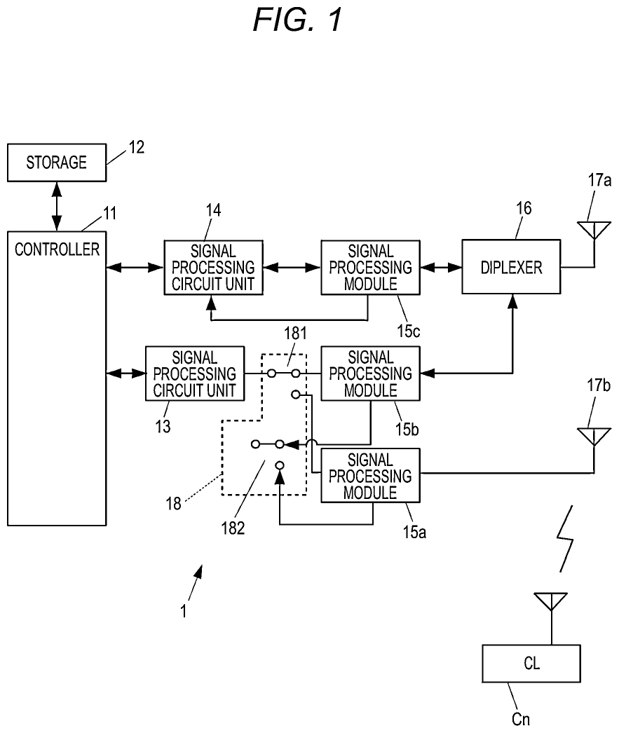

Embodiments of the present disclosure will be described with reference to the drawings. As a basic example (an example of a dual band) is shown in FIG. 1, a wireless communication device 1 according to an example of an embodiment of the present disclosure includes a controller 11, a storage unit 12, a plurality of signal processing circuit units 13 and 14, first and second signal processing modules 15a and 15b provided to correspond to the signal processing circuit unit 13, a third signal processing module 15c provided to correspond to the signal processing circuit unit 14, a diplexer 16, antennas 17a and 17b, and a switch module 18.

Here, the controller 11 includes a program control device such as a central processing unit (CPU) and operates in accordance with a program stored in the storage unit 12. In the example of the present embodiment, the controller 11 controls each unit illustrated in FIG. 1 and outputs communication target information to at least one of the signal processing circuit unit 13 and the signal processing circuit unit 14 for transmission as a wireless signal. Furthermore, the controller 11 accepts information, which is output by the signal processing circuit unit 13 or the signal processing circuit unit 14 receiving and demodulating a signal arriving at the antenna 17 (hereinafter, when there is no need to distinguish the antennas 17a and 17b, they are collectively described as antenna 17), and executes predetermined processing on the information (for example, processing of transmitting the information via a wired network, and the like).

In addition, in an example of the present embodiment, the controller 11 accepts a setting of a frequency band to be used from a user of the wireless communication device 1, stores the setting in the storage unit 12, and controls each unit based on the setting. The operations of the controller 11 will be described below.

The storage unit 12 is a memory device, or the like, and holds a program and the like that are executed by the controller 11. Furthermore, the storage unit 12 also operates as a work memory for the controller 11. Furthermore, the storage unit 12 may have a non-volatile storage area and may hold information such as a setting in accordance with an instruction input from the controller 11, regardless of whether a power supply is turned on or off. In the example of the present embodiment, the program stored in the storage unit 12 may be provided with being stored on a computer-readable, non-transitory recording medium. Alternatively, the program may be transmitted via a communication means such as a network and stored in the storage unit 12.

The plurality of signal processing circuit units 13 and 14 generate or demodulate wireless signals in different frequency bands, respectively. Specifically, the signal processing circuit units 13 and 14 each include a baseband chip. The signal processing circuit units 13 and 14 each accept and modulate communication target information output by the controller 11, and generate a wireless signal in the corresponding frequency band. Then, the signal processing circuit unit 13 outputs the generated wireless signal to the corresponding first or second signal processing module 15a or 15b. In addition, the signal processing circuit unit 14 outputs the generated wireless signal to the corresponding third signal processing module 15c.

In addition, the signal processing circuit unit 13 demodulates a signal input from the corresponding first or second signal processing module 15a or 15b and outputs information obtained by the demodulation to the controller 11. In addition, the signal processing circuit unit 14 demodulates a signal input from the corresponding third signal processing module 15c and outputs information obtained by the demodulation to the controller 11.

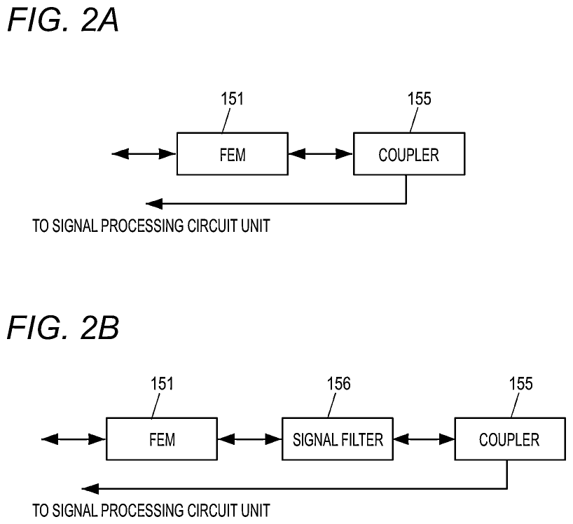

As illustrated in FIG. 2A, the signal processing module 15 (hereinafter, when there is no need to distinguish the first, second, and third signal processing modules 15a, 15b, and 15c, they are simply referred to as signal processing module 15) includes a front-end module 151 including a tuner, an amplifier, and the like. Furthermore, the signal processing module 15 may further include a coupler 155 that detects the strength of a signal transmitted by a signal line.

In another example, the signal processing module 15 may include a front-end module 151, a coupler 155, and a signal filter 156, as illustrated in FIG. 2B. Here, the signal filter 156 is a wireless signal filter (RF filter) and passes a wireless signal in a predetermined corresponding band. Note that the arrangement order of the coupler 155 and the signal filter 156 may be reversed, so that the signal filter 156 may be directly connected to the front-end module 151 and the coupler 155 may be provided at a rear end (antenna side) of the signal filter 156. In addition, in this latter example, the signal filter 156 may be built into the front-end module 151 (the same applies to each example below).

The diplexer 16 operates as a signal synthesis module, mixes signals output from the second signal processing module 15b and the third signal processing module 15c and outputs the mixed signal to the antenna 17a, and splits a signal arriving at the antenna 17a into signals in frequency bands corresponding to the second signal processing module 15b and the third signal processing module 15c and outputs the split signals to the second signal processing module 15b and the third signal processing module 15c corresponding to the respective frequency bands.

In the example of FIG. 1, the antenna 17a is connected to the second signal processing module 15b and the third signal processing module 15c via the diplexer 16, and the antenna 17b is connected to the first signal processing module 15a.

The switch module 18 includes a switch that selectively connects any one of the first signal processing module 15a and the second signal processing module 15b to the signal processing circuit unit 13 in response to an instruction input from the controller 11. In an example of the present embodiment, the switch module 18 includes a first switch 181 and a second switch 182, as illustrated in FIG. 1. The first switch 181 selectively outputs a wireless signal output by the signal processing circuit unit 13 to any one of the first signal processing module 15a and the second signal processing module 15b. Furthermore, the first switch 181 outputs a signal output by the selected signal processing module of the first signal processing module 15a and the second signal processing module 15b to the signal processing circuit unit 13.

In addition, the second switch 182 operates in cooperation with the first switch 181, and when the first switch 181 connects the signal processing circuit unit 13 and the first signal processing module 15a, the second switch 182 connects the coupler 155 included in the first signal processing module 15a and the signal processing circuit unit 13. Furthermore, when the first switch 181 connects the signal processing circuit unit 13 and the second signal processing module 15b, the second switch 182 connects the coupler 155 included in the second signal processing module 15b and the signal processing circuit unit 13.

### Operations

The wireless communication device 1 according to an example of the present embodiment has the above-described configuration and operates as follows. Note that in the example below, the signal processing circuit unit 13 functions as a 5, 6 GHz signal processing circuit unit that generates or demodulates a wireless signal in a 5 GHz band or 6 GHz band, and the signal processing circuit unit 14 functions as a 2.4 GHz signal processing circuit unit that generates or demodulates a wireless signal in a 2.4 GHz band.

In addition, the signal processing circuit unit 13 is connected to the first and second signal processing modules 15a and 15b that respectively process wireless signals in different first and second bands (here, respective frequency bands of the 5 GHz band and the 6 GHz band), via the switch module 18. In the following, the signal processing circuit unit connected to correspond to a plurality of signal processing modules is called a first-type signal processing circuit unit.

In addition, the signal processing circuit unit 14 is connected to the third signal processing module 15c that processes a wireless signal in a third band (here, 2.4 GHz), which is further different from the first and second bands. In the below, the signal processing circuit unit corresponding to a single signal processing module is hereinafter referred to as a second-type signal processing circuit unit.

In the following example of the present embodiment, the first signal processing module 15a includes the front-end module 151, the coupler 155, and the signal filter 156, as illustrated in FIG. 2B. In addition, the second and third signal processing modules 15b and 15c each include the front-end module 151 and the coupler 155, as illustrated in FIG. 2A, and are connected to the antenna 17a via the diplexer 16.

The controller 11 accepts a setting from the user. In some examples of the present embodiment, the controller 11 may include, for example, a wired network interface and accept a setting via a wired network connected via the wired network interface. Alternatively, the controller 11 accepts a setting by any one of a variety of well-known methods, such as a method of accepting a setting by causing a user to operate a changeover switch (a slide switch, or the like). The controller 11 may store a content of the setting in a non-volatile memory area of the storage unit 12.

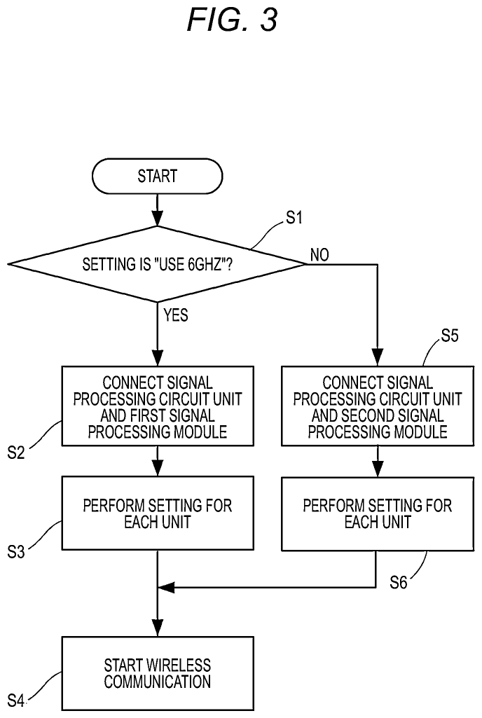

In the example here, the setting is a setting as to “whether to use 6 GHz”. The controller 11 accepts the setting (or reads the setting from the storage unit 12) at a predetermined timing when a device is initialized, such as at the time when the wireless communication device 1 is turned on or a reset timing, and starts processing illustrated in FIG. 3.

The controller 11 determines whether the accepted (or read) setting is a setting “Use 6 GHz” (S1). If the setting is a setting “Use 6 GHz” (S1: Yes), the controller 11 controls the switch module 18 to connect the signal processing circuit unit 13 and the first signal processing module 15a (S2). Here, the first switch 181 is switched to connect the signal processing circuit unit 13 to the front-end module 151 of the first signal processing module 15a, and the second switch 182 is switched to connect the signal processing circuit unit 13 and the coupler 155 of the first signal processing module 15a.

In addition, the controller 11 sets each unit (e.g., each front-end module 151 of the first to third signal processing modules 15a, 15b, and 15c) to perform communication in the corresponding frequency band, and sets a setting of an output (power) and the like to a value determined in advance as a setting at the time when “using 6 GHz” (S3: parameter setting). Then, the controller 11 starts wireless communication (S4).

On the other hand, in step S1, if the setting is a setting “Do not use 6 GHz” (S1: No), the controller 11 controls the switch module 18 to connect the signal processing circuit unit 13 and the second signal processing module 15b (S5). Here, the first switch 181 is switched to connect the signal processing circuit unit 13 to the front-end module 151 of the second signal processing module 15b, and the second switch 182 is switched to connect the signal processing circuit unit 13 and the coupler 155 of the second signal processing module 15b.

In addition, the controller 11 sets each unit (e.g., each front-end module 151 of the first to third signal processing modules 15a, 15b, and 15c) to perform communication in the corresponding frequency band, and sets a setting of an output (power) and the like to a value determined in advance as a setting at the time when “not using 6 GHz” (S6: parameter setting). Then, the controller 11 proceeds to step S4 and performs communication.

When the setting “Use 6 GHz” is made, a wireless signal of a wireless communication client C1 communicating at 6 GHz is input to the first signal processing module 15a via the antenna 17b. Then, the wireless signal is input to the front-end module 151 via the coupler 155 after a wireless signal in the 6 GHz band is selectively passed by the signal filter 156 of the first signal processing module 15a. The front-end module 151 of the first signal processing module 15a performs predetermined processing such as filtering on the wireless signal and outputs the processed signal to the signal processing circuit unit 13 connected via the switch module 18.

The signal processing circuit unit 13 demodulates the wireless signal of the wireless communication client C1 communicating in the 6 GHz band and outputs information obtained by the demodulation to the controller 11. In this way, the controller 11 obtains information transmitted by the wireless communication client C1 communicating in the 6 GHz band. On the other hand, the controller 11 outputs information, which is to be transmitted to the wireless communication client C1 communicating in the 6 GHz band, to the signal processing circuit unit 13. Note that the controller 11 stores in advance information identifying each wireless communication client C in association with information indicating in which frequency band each wireless communication client will communicate.

The signal processing circuit unit 13 accepts communication target information input from the controller 11, modulates the information into a wireless signal, and generates a wireless signal in the corresponding frequency band (here, 6 GHz band). Here, since the signal processing circuit unit 13 is connected to the first signal processing module 15a via the switch module 18, the signal processing circuit unit 13 outputs the generated wireless signal to the first signal processing module 15a.

Then, the front-end module 151 of the first signal processing module 15a performs predetermined processing such as filtering on the wireless signal and outputs the processed wireless signal to the signal filter 156 via the coupler 155. Here, the coupler 155 obtains information such as the strength of the wireless signal output by the front-end module 151 and feeds it back to the signal processing circuit unit 13. The signal processing circuit unit 13 refers to the feedback and controls the strength and the like of the wireless signal to be generated.

On the other hand, the signal filter 156 causes a wireless signal in the 6 GHz band to selectively pass therethrough from the wireless signal output by the front-end module 151 and radiates the wireless signal via the antenna 17b. Then, the wireless signal reaches the wireless communication client C1 communicating in the 6 GHz band.

On the other hand, a wireless signal of a wireless communication client C2 communicating in the 2.4 GHz band is distributed by the diplexer 16 via the antenna 17a and input to the second signal processing module 15b and the third signal processing module 15c. Here, since the second signal processing module 15b processes signals in a 5 GHz band, signals in the 2.4 GHz band are not filtered and handled. Here, the second signal processing module 15b is not connected to the signal processing circuit unit 13 and, therefore, does not function.

The wireless signal input to the third signal processing module 15c is input to the front-end module 151 via the coupler 155 of the third signal processing module 15c. The front-end module 151 of the third signal processing module 15c performs predetermined processing such as filtering on the wireless signal and outputs the wireless signal to the signal processing circuit unit 14.

The signal processing circuit unit 14 demodulates the wireless signal of the wireless communication client C2 communicating in the 2.4 GHz band and outputs information obtained by the demodulation to the controller 11. In this way, the controller 11 obtains the information transmitted by the wireless communication client C2 communicating in the 2.4 GHz band. On the other hand, the controller 11 outputs information, which is to be transmitted to the wireless communication client C2 communicating in the 2.4 GHz band, to the signal processing circuit unit 14.

The signal processing circuit unit 14 accepts communication target information input from the controller 11, modulates the information into a wireless signal, and generates a wireless signal in the corresponding frequency band (here, 2.4 GHz band). The signal processing circuit unit 14 outputs the generated wireless signal to the third signal processing module 15c.

Then, the front-end module 151 of the third signal processing module 15c performs predetermined processing such as filtering on the wireless signal and outputs the processed wireless signal to the diplexer 16 via the coupler 155. At this time, the coupler 155 obtains information such as the strength of the wireless signal output by the front-end module 151 and feeds it back to the signal processing circuit unit 14. The signal processing circuit unit 14 refers to the feedback and controls the strength and the like of the wireless signal to be generated.

The diplexer 16 radiates the wireless signal output by the third signal processing module 15c via the antenna 17a. Then, the wireless signal reaches the wireless communication client C2 communicating in the 2.4 GHz band.

In addition, in the case where the setting “Do not use 6 GHz” is made as the setting, since the first signal processing module 15a is not connected to the signal processing circuit unit 13 and is not functioning, the wireless signal of the wireless communication client C1 communicating in the 6 GHz band is not received even if it arrives at the antenna 17b.

In this way, in the case where the setting “Do not use 6 GHz” is made, a wireless signal of a wireless communication client C3 communicating in the 5 GHz band is distributed by the diplexer 16 via the antenna 17a and input to the second signal processing module 15b and the third signal processing module 15c. Here, since the third signal processing module 15c processes signals in the 2.4 GHz band, signals in the 5 GHz band are not filtered and handled.

The wireless signal input to the second signal processing module 15b is input to the front-end module 151 via the coupler 155 of the second signal processing module 15b. The front-end module 151 of the second signal processing module 15b performs predetermined processing such as filtering on the wireless signal and outputs the processed signal to the signal processing circuit unit 13 connected via the switch module 18.

The signal processing circuit unit 13 demodulates the wireless signal of the wireless communication client C3 communicating in the 5 GHz band, and outputs information obtained by the demodulation to the controller 11. In this way, the controller 11 obtains information transmitted by the wireless communication client C3 communicating in the 5 GHz band. On the other hand, the controller 11 outputs information, which is to be transmitted to the wireless communication client C3 communicating in the 5 GHz band, to the signal processing circuit unit 13.

The signal processing circuit unit 13 accepts communication target information input from the controller 11, modulates the information into a wireless signal, and generates a wireless signal in the corresponding frequency band (here, 5 GHz band). The signal processing circuit unit 13 outputs the generated wireless signal to the second signal processing module 15b connected via the switch module 18.

Then, the front-end module 151 of the second signal processing module 15b performs predetermined processing such as filtering on the wireless signal and outputs the processed wireless signal to the diplexer 16 via the coupler 155. Here, the coupler 155 obtains information such as the strength of the wireless signal output by the front-end module 151 and feeds it back to the signal processing circuit unit 13. The signal processing circuit unit 13 refers to the feedback and controls the strength and the like of the wireless signal to be generated.

The diplexer 16 mixes the wireless signal output from the second signal processing module 15b and the wireless signal output from the third signal processing module 15c and radiates the mixed signal via the antenna 17a. Then, the wireless signal reaches the wireless communication client C3 communicating in the 5 GHz band.

At this time, the wireless signal of the wireless communication client C2 communicating in the 2.4 GHz band is distributed by the diplexer 16 via the antenna 17a and input to the second signal processing module 15b and the third signal processing module 15c. Here, since the third signal processing module 15b processes signals in the 5 GHz band, signals in the 2.4 GHz band are not filtered and handled.

The wireless signal input to the third signal processing module 15c is input to the front-end module 151 via the coupler 155 of the third signal processing module 15c. The front-end module 151 of the third signal processing module 15c performs predetermined processing such as filtering on the wireless signal and outputs the wireless signal to the signal processing circuit unit 14.

The signal processing circuit unit 14 demodulates the wireless signal of the wireless communication client C2 communicating in the 2.4 GHz band, and outputs information obtained by the demodulation to the controller 11. In this way, the controller 11 obtains the information transmitted by the wireless communication client C2 communicating in the 2.4 GHz band. On the other hand, the controller 11 outputs information, which is to be transmitted to the wireless communication client C2 communicating in the 2.4 GHz band, to the signal processing circuit unit 14.

The signal processing circuit unit 14 accepts communication target information input from the controller 11, modulates the information into a wireless signal, and generates a wireless signal in the corresponding frequency band (here, 2.4 GHz band). The signal processing circuit unit 14 outputs the generated wireless signal to the third signal processing module 15c.

Then, the front-end module 151 of the third signal processing module 15c performs predetermined processing such as filtering on the wireless signal and outputs the processed wireless signal to the diplexer 16 via the coupler 155. Here, the coupler 155 obtains information such as the strength of the wireless signal output by the front-end module 151 and feeds it back to the signal processing circuit unit 14. The signal processing circuit unit 14 refers to the feedback and controls the strength and the like of the wireless signal to be generated.

The diplexer 16 mixes the wireless signal output from the second signal processing module 15b and the wireless signal output from the third signal processing module 15c and radiates the mixed signal via the antenna 17a. Then, the wireless signal reaches the wireless communication client C2 communicating in the 2.4 GHz band.

### Effects of Embodiment

In this way, according to the example of the present embodiment, either 5 GHz+2.4 GHz or 6 GHz+2.4 GHz can be selected. Therefore, while corresponding to wireless communication in multiple frequency bands, the relatively expensive signal processing circuit unit is switched and connected to the 5 GHz or 6 GHz front-end module (relatively inexpensive circuit unit), making it possible to suppress an increase in device cost.

### <Configuration of Tri-Band>

In addition, the configuration of the present embodiment is not limited to the dual-band configuration as described above, and can also be used when configured as a tri-band.

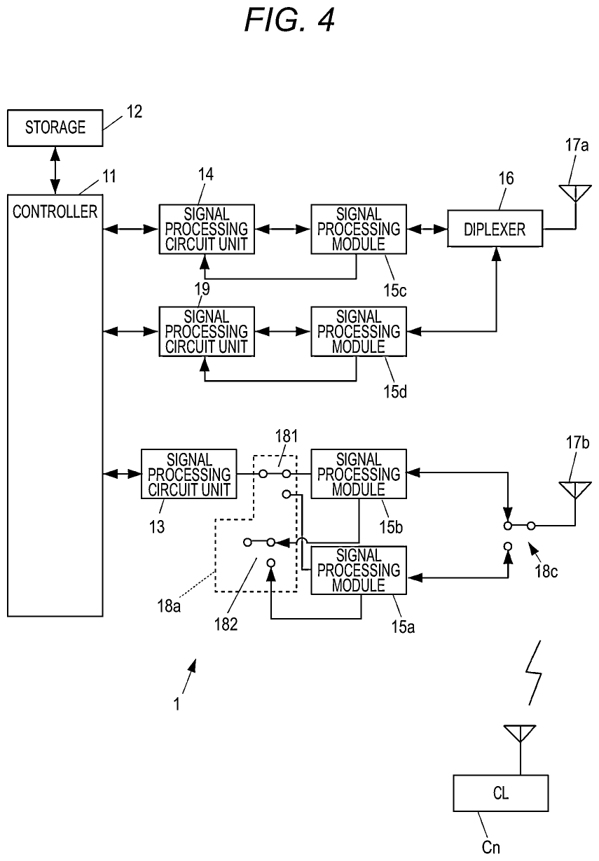

In the tri-band configuration, as illustrated in FIG. 4, a signal processing circuit unit 13, which is a first-type signal processing circuit unit, and second-type signal processing circuit units 14 and 19 are provided, and the signal processing circuit units 13, 14, and 19 correspond to different frequency bands (for example, 5 to 6 GHZ, 2.4 GHz, and 5 GHz), respectively. Furthermore, in the example of FIG. 4, the configuration of the signal processing module 15 connected to each of the signal processing circuit units 13, 14, and 19 is different from the example of the dual band of FIG. 1.

A wireless communication device 1 having a tri-band configuration according to the example in FIG. 4 includes a controller 11, a storage unit 12, a plurality of signal processing circuit units 13, 14, and 19, first and second signal processing modules 15a and 15b provided to correspond to the signal processing circuit unit 13, third and fourth signal processing modules 15c and 15d provided to correspond to the signal processing circuit units 14 and 19, respectively, a diplexer 16, antennas 17a and 17b, and switch modules 18a, 18b, and 18c.

In this example as well, the controller 11 controls each unit illustrated in FIG. 4 and outputs communication target information to at least one of the signal processing circuit unit 13, the signal processing circuit unit 14, and the signal processing circuit unit 19 for transmission as a wireless signal. Furthermore, the controller 11 accepts information, which is output by the signal processing circuit units 13, 14, and 19 receiving and demodulating signals arriving at the antennas 17, and executes predetermined processing on the information (for example, processing of transmitting the information via a wired network, and the like). Since the storage unit 12 is similar to that illustrated in FIG. 1, repeated description will be omitted.

The plurality of signal processing circuit units 13, 14, and 19 generate or demodulate wireless signals in different frequency bands, respectively. Specifically, the signal processing circuit units 13, 14, and 19 each include a baseband chip, accept and modulate communication target information output by the controller 11, and generate a wireless signal in the corresponding frequency band.

In addition, in the example of FIG. 4, the signal processing circuit unit 13 is connected to the first and second signal processing modules 15a and b via the switch module 18a and transmits the generated wireless signal to any one of the first and second signal processing modules 15a and 15b. In addition, the signal processing circuit units 14 and 19 output the generated wireless signals to the corresponding third and fourth signal processing modules 15c and 15d, respectively.

Furthermore, the signal processing circuit unit 13 demodulates a signal input from the corresponding first or second signal processing module 15a or 15b and outputs information obtained by the demodulation to the controller 11. Furthermore, the signal processing circuit units 14 and 19 demodulate signals input from the corresponding third and fourth signal processing modules 15c and 15d and output information obtained by the demodulation to the controller 11.

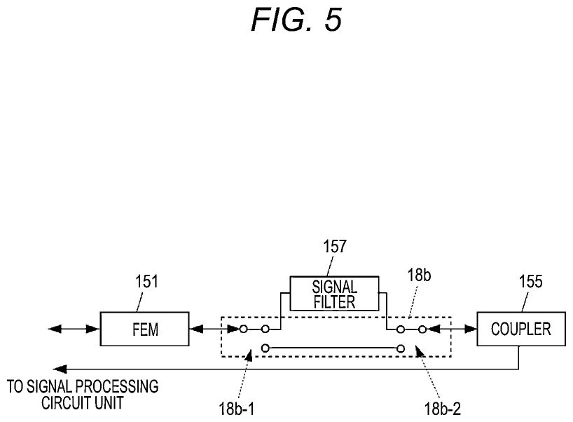

The signal processing module 15 (hereinafter, when there is no need to distinguish the first to fourth signal processing modules 15a, 15b, 15c, and 15d, they are simply referred to as signal processing module 15) has the configuration illustrated in FIGS. 2A and 2B, respectively. Note that in this example of the present embodiment, the fourth signal processing module 15d includes a front-end module 151, a switch module 18b described below, a signal filter 157, and a coupler 155, as illustrated in FIG. 5. Here, the signal filter 157 is a wireless signal (RF) filter similar to the signal filter 156 and passes a signal in a predetermined frequency band. Here, the predetermined frequency band may be a frequency band relatively distant from a frequency band of the first signal processing module 15a (more distant than an interval between the corresponding frequency bands of the first signal processing module 15a and the second signal processing module 15b).

The diplexer 16 mixes signals output from the third signal processing module 15c and the fourth signal processing module 15d and outputs the mixed signal to the antenna 17a, and splits a signal arriving at the antenna 17a into signals in frequency bands corresponding to the third signal processing module 15c and the fourth signal processing module 15d and outputs the split signals to the fourth signal processing module 15c and the fourth signal processing module 15d corresponding to the respective frequency bands.

In the example of FIG. 4, the antenna 17a is connected to the third signal processing module 15c and the fourth signal processing module 15d via the diplexer 16, and the antenna 17b is connected to any one of the first signal processing module 15a and the second signal processing modules 15b via the switch module 18c. The switch module 18c functions as an antenna-side switch module of the present disclosure. Originally, in this example, the first signal processing module 15a and the second signal processing module 15b may be connected to different antennas 17, respectively.

The switch module 18 includes a switch that selectively connects any one of the first signal processing module 15a and the second signal processing module 15b to the signal processing circuit unit 13 in response to an instruction input from the controller 11. In an example of the present embodiment, the switch module 18a includes a first switch 181 and a second switch 182, as illustrated in FIG. 4. The first switch 181 selectively outputs the wireless signal output by the signal processing circuit unit 13 to any one of the first signal processing module 15a and the second signal processing module 15b and, simultaneously, outputs a signal output by any one selected module of the first signal processing module 15a and the second signal processing module 15b to the signal processing circuit unit 13.

In addition, the second switch 182 operates in cooperation with the first switch 181, and when the first switch 181 connects the signal processing circuit unit 13 and the first signal processing module 15a, the second switch 182 connects the coupler 155 included in the first signal processing module 15a and the signal processing circuit unit 13. Furthermore, when the first switch 181 connects the signal processing circuit unit 13 and the second signal processing module 15b, the second switch 182 connects the coupler 155 included in the second signal processing module 15b and the signal processing circuit unit 13.

In addition, the switch module 18b included in the fourth signal processing module 15d functions as a filter switch module that switches a path connecting the front-end module 151 of the fourth signal processing module 15d to the coupler 155 of the fourth signal processing module 15d via the signal filter 157 and a path connecting (bypassing) the front-end module 151 of the fourth signal processing module 15d to the coupler 155 of the fourth signal processing module 15d without intervening the signal filter 157.

The switch module 18b includes a pair of switches 18b-1 and 18b-2 each operating in cooperation with the switch module 18a, and connects the front-end module 151 of the fourth signal processing module 15d to the coupler 155 of the fourth signal processing module 15d via the signal filter 157 while the first switch 181 of the switch module 18a connects the signal processing circuit unit 13 and the first signal processing module 15a. Furthermore, the switch module 18b connects the front-end module 151 of the fourth signal processing module 15d to the coupler 155 of the fourth signal processing module 15d without intervening the signal filter 157 while the first switch 181 of the switch module 18a connects the signal processing circuit unit 13 and the second signal processing module 15b.

The switch module 18c connects any one of the first and second signal processing modules 15a and 15b to the antenna 17b. The switch module 18c operates in cooperation with the switch module 18a, and connects the first signal processing module 15a to the antenna 17b while the first switch 181 of the switch module 18a connects the signal processing circuit unit 13 and the first signal processing module 15a. Furthermore, the switch module 18c connects the second signal processing module 15b to the antenna 17b while the first switch 181 of the switch module 18a connects the signal processing circuit unit 13 and second first signal processing module 15b.

### <Operations of Tri-Band Configuration>

The wireless communication device 1 having the tri-band configuration according to the example in FIG. 4 basically has the above configuration and operates as follows. Note that in the example below, the signal processing circuit unit 13 functions as a 5, 6 GHz signal processing circuit unit that generates or demodulates a wireless signal in a 5 GHz band or 6 GHz band, and the signal processing circuit unit 14 functions as a 2.4 GHz signal processing circuit unit that generates or demodulates a wireless signal in a 2.4 GHz band. In addition, the signal processing circuit unit 19 functions as a 5 GHz signal processing circuit unit that generates or demodulates a wireless signal in the 5 GHz band.

In addition, the signal processing circuit unit 13 is connected to the first and second signal processing modules 15a and 15b that respectively process wireless signals in different first and second bands (here, respective frequency bands of a relatively high frequency band of the 5 GHz band (hereinafter, referred to as 5 GHzHigh) and a 6 GHz band), via the switch module 18. Here, the relatively high frequency band of the 5 GHz band corresponds to, for example, a band of 5.47 GHz to 5.73 GHz (W56 band referred to in the guidelines of the Japan Electronics and Information Technology Industries Association (JEITA)), and the like.

In addition, the signal processing circuit unit 14 is connected to the third signal processing module 15c that processes a wireless signal in a third band (here, 2.4 GHz) further different from the first and second bands, and the signal processing circuit unit 19 is connected to the fourth signal processing module 15d that processes a wireless signal in a fourth band (herein, the 5 GHz band or a relatively low frequency band of the 5 GHz band (hereinafter, referred to as 5 GHzLow)) different from the first and third bands. Here, the relatively low frequency band of the 5 GHz band corresponds to, for example, a band of 5.15 GHz to 5.25 GHz, a band of 5.25 GHz to 5.35 GHz (so-called W52 and W53 bands), and the like.

In the following example of the present embodiment, as illustrated in FIG. 2B, the first and second signal processing modules 15a and 15b each include a front-end module 151, a coupler 155, and a signal filter 156 (the signal filter 156 passes signals in the corresponding 6 GHz and 5 GHzHigh frequency bands in the first and second signal processing modules 15a and 15b, respectively). In addition, the third signal processing module 15c includes a front-end module 151 and a coupler 155, as illustrated in FIG. 2A, and is connected to the antenna 17a via the diplexer 16, and the fourth signal processing module 15d has the configuration illustrated in FIG. 5 and is connected to the antenna 17a via the diplexer 16.

The controller 11 accepts a setting from the user. In this example, it is assumed that this setting indicates, as a tri-band, any one of:
(Setting a) Use in 3 bands of 2.4 GHz+5 GHz+6 GHz, and
(Setting b) Use in 3 bands of 2.4 GHz+5 GHzLow+5 GHzHigh.

The controller 11 accepts the setting (or reads the setting from the storage unit 12) at a predetermined timing when a device is initialized such as at the time when the wireless communication device 1 is turned on or a reset timing, and starts processing similar to that illustrated in FIG. 3.

The controller 11 determines whether the accepted (or read) setting is Setting a (Use in 3 bands of 2.4 GHz+5 GHz+6 GHz) or Setting b (Use in 3 bands of 2.4 GHz+5 GHzLow+5 GHzHigh). Here, if the setting is Setting a, the controller 11 controls the switch modules 18a, 18b, and 18c to connect the signal processing circuit unit 13 and the first signal processing module 15a, and also connects the front-end module 151 to the coupler 155 without intervening the signal filter 157 inside the fourth signal processing module 15d. Additionally, the controller connects the first signal processing module 15a and the antenna 17b.

At this time, the first switch 181 is switched to connect the signal processing circuit unit 13 to the front-end module 151 of the first signal processing module 15a, and the second switch 182 is switched to connect the signal processing circuit unit 13 and the coupler 155 of the first signal processing module 15a.

Additionally, the controller 11 sets each unit to perform communication in a corresponding frequency band. In this example, the controller 11 sets the signal processing circuit unit 13, which is a 5, 6 GHz signal processing circuit unit, to process a wireless signal in the 6 GHz band. Additionally, the controller 11 sets a setting of an output (power) and the like to a value determined in advance in accordance with Setting a. Then, the controller 11 starts wireless communication.

On the other hand, if the accepted setting is Setting b, the controller 11 controls the switch modules 18a, 18b, and 18c to connect the signal processing circuit unit 13 and the second signal processing module 15b, and also connects the front-end module 151 to the coupler 155 via the signal filter 157 inside the fourth signal processing module 15d. Additionally, the controller connects the second signal processing module 15b and the antenna 17b.

At this time, the first switch 181 is switched to connect the signal processing circuit unit 13 to the front-end module 151 of the second signal processing module 15b, and the second switch 182 is switched to connect the signal processing circuit unit 13 and the coupler 155 of the second signal processing module 15b.

Additionally, the controller 11 sets each unit to perform communication in a corresponding frequency band. In this example, the controller 11 sets the signal processing circuit unit 13, which is a 5, 6 GHz signal processing circuit unit, to process a wireless signal in the 5 GHz band. The controller sets a setting of an output (power) and the like to a value determined in advance for Setting b. Then, the controller 11 performs communication.

In the case of Setting a, a wireless signal of the wireless communication client C1 communicating at 6 GHz is input to the first signal processing module 15a via the antenna 17b and the switch module 18c. Then, the wireless signal is input to the front-end module 151 via the coupler 155 after a wireless signal in the 6 GHz band is selectively passed by the signal filter 156 of the first signal processing module 15a. The front-end module 151 of the first signal processing module 15a performs predetermined processing such as filtering on the wireless signal and outputs the processed signal to the signal processing circuit unit 13 connected via the switch module 18.

The signal processing circuit unit 13 demodulates the wireless signal of the wireless communication client C1 communicating in the 6 GHz band and outputs information obtained by the demodulation to the controller 11. In this way, the controller 11 obtains information transmitted by the wireless communication client C1 communicating in the 6 GHz band.

On the other hand, the controller 11 outputs information, which is to be transmitted to the wireless communication client C1 communicating in the 6 GHz band, to the signal processing circuit unit 13. Note that the controller 11 stores in advance information identifying each wireless communication client C in association with information indicating in which frequency band each wireless communication client will communicate.

The signal processing circuit unit 13 accepts communication target information input from the controller 11, modulates the information into a wireless signal, and generates a wireless signal in the corresponding frequency band (here, 6 GHz band). Here, since the signal processing circuit unit 13 is connected to the first signal processing module 15a via the switch module 18a, the signal processing circuit unit 13 outputs the generated wireless signal to the first signal processing module 15a.

Then, the front-end module 151 of the first signal processing module 15a performs predetermined processing such as filtering on the wireless signal and outputs the processed wireless signal to the signal filter 156 via the coupler 155. Here, the coupler 155 obtains information such as the strength of the wireless signal output by the front-end module 151 and feeds it back to the signal processing circuit unit 13. The signal processing circuit unit 13 refers to the feedback and controls the strength and the like of the wireless signal to be generated.

On the other hand, the signal filter 156 causes a wireless signal in the 6 GHz band to selectively pass therethrough from the wireless signal output by the front-end module 151 and outputs the same to the antenna 17b via the switch module 18c, and the antenna 17b radiates the wireless signal. Then, the wireless signal reaches the wireless communication client C1 communicating in the 6 GHz band.

On the other hand, a wireless signal of a wireless communication client C2 communicating in the 2.4 GHz band is distributed by the diplexer 16 via the antenna 17a and input to the third signal processing module 15c and the fourth signal processing module 15d. Here, since the fourth signal processing module 15d processes signals in the 5 GHz band, signals in the 2.4 GHz band are not filtered and handled.

The wireless signal input to the third signal processing module 15c is input to the front-end module 151 via the coupler 155 of the third signal processing module 15c. The front-end module 151 of the third signal processing module 15c performs predetermined processing such as filtering on the wireless signal and outputs the wireless signal to the signal processing circuit unit 14.

The signal processing circuit unit 14 demodulates the wireless signal of the wireless communication client C2 communicating in the 2.4 GHz band and outputs information obtained by the demodulation to the controller 11. In this way, the controller 11 obtains the information transmitted by the wireless communication client C2 communicating in the 2.4 GHz band. On the other hand, the controller 11 outputs information, which is to be transmitted to the wireless communication client C2 communicating in the 2.4 GHz band, to the signal processing circuit unit 14.

The signal processing circuit unit 14 accepts communication target information input from the controller 11, modulates the information into a wireless signal, and generates a wireless signal in the corresponding frequency band (here, 2.4 GHz band). The signal processing circuit unit 14 outputs the generated wireless signal to the third signal processing module 15c.

Then, the front-end module 151 of the third signal processing module 15c performs predetermined processing such as filtering on the wireless signal and outputs the processed wireless signal to the diplexer 16 via the coupler 155. Here, the coupler 155 obtains information such as the strength of the wireless signal output by the front-end module 151 and feeds it back to the signal processing circuit unit 14. The signal processing circuit unit 14 refers to the feedback and controls the strength and the like of the wireless signal to be generated.

The diplexer 16 radiates the wireless signal output by the third signal processing module 15c via the antenna 17a. Then, the wireless signal reaches the wireless communication client C2 communicating in the 2.4 GHz band.

In addition, a wireless signal of a wireless communication client C4 communicating in the 5 GHz band is distributed by the diplexer 16 via the antenna 17a and input to the third signal processing module 15c and the fourth signal processing module 15d. Here, since the third signal processing module 15c processes signals in the 2.4 GHz band, signals in the 5 GHz band are not filtered and handled.

The wireless signal input to the fourth signal processing module 15d is input to the front-end module 151 via the coupler 155 of the fourth signal processing module 15d. The front-end module 151 of the fourth signal processing module 15d performs predetermined processing such as filtering on the wireless signal and outputs the wireless signal to the signal processing circuit unit 19.

The signal processing circuit unit 19 demodulates the wireless signal of the wireless communication client C4 communicating in the 5 GHz band and outputs information obtained by the demodulation to the controller 11. In this way, the controller 11 obtains the information transmitted by the wireless communication client C4 communicating in the 5 GHz band. On the other hand, the controller 11 outputs information, which is to be transmitted to the wireless communication client C4 communicating in the 5 GHz band, to the signal processing circuit unit 19.

The signal processing circuit unit 19 accepts communication target information input from the controller 11, modulates the information into a wireless signal, and generates a wireless signal in the corresponding frequency band (here, 5 GHz band). The signal processing circuit unit 19 outputs the generated wireless signal to the fourth signal processing module 15d.

The front-end module 151 of the fourth signal processing module 15d performs predetermined processing such as filtering on the wireless signal. Here, since the front-end module 151 is connected to the coupler 155 without intervening the signal filter 157 inside the fourth signal processing module 15d, the wireless signal processed by this front-end module 151 is output to the diplexer 16 via the coupler 155, as it is. Here, the coupler 155 obtains information such as the strength of the wireless signal output by the front-end module 151 and feeds it back to the signal processing circuit unit 19. The signal processing circuit unit 19 refers to the feedback and controls the strength and the like of the wireless signal to be generated.

The diplexer 16 radiates the wireless signal output by the fourth signal processing module 15d via the antenna 17a. Then, the wireless signal reaches the wireless communication client C2 communicating in the 5 GHz band.

Next, in the case where the setting is Setting b (setting to the effect of use in 3 bands of 2.4 GHz+5 GHzLow+5 GHzHigh), since the first signal processing module 15a is not connected to the signal processing circuit unit 13, both the antenna 17b and the first signal processing module 15a are disconnected by the switch module 18c, and, therefore, the first signal processing module 15a is not functioning, the wireless signal of the wireless communication client C1 communicating in the 6 GHz band is not received even if it arrives at the antenna 17b.

In this way, in the case of Setting b, when a wireless signal of a wireless communication client C5 communicating in the relatively high frequency band (5 GHzHigh) of the 5 GHz band arrives at the antenna 17b, the wireless signal is input to the second signal processing module 15b via the switch module 18c.

Then, the wireless signal is input to the front-end module 151 via the coupler 155 after a wireless signal in the 5 GHzHigh band is selectively passed by the signal filter 156 of the second signal processing module 15b. The front-end module 151 of the second signal processing module 15b performs predetermined processing such as filtering on the wireless signal and outputs the processed wireless signal to the signal processing circuit unit 13 connected via the switch module 18a.

The signal processing circuit unit 13 demodulates the wireless signal of the wireless communication client C5 communicating in the 5 GHzHigh band, and outputs information obtained by the demodulation to the controller 11. In this way, the controller 11 obtains information transmitted by the wireless communication client C5 communicating in the 5 GHzHigh band.

On the other hand, the controller 11 outputs information, which is to be transmitted to the wireless communication client C5 communicating in the 5 GHzHigh band, to the signal processing circuit unit 13.

The signal processing circuit unit 13 accepts communication target information input from the controller 11, modulates the information into a wireless signal, and generates a wireless signal in the corresponding frequency band (here, set to 5 GHzHigh band). Here, since the signal processing circuit unit 13 is connected to the second signal processing module 15b via the switch module 18a, the signal processing circuit unit 13 outputs the generated wireless signal to the second signal processing module 15b.

Then, the front-end module 151 of the second signal processing module 15b performs predetermined processing such as filtering on the wireless signal and outputs the processed wireless signal to the signal filter 156 via the coupler 155. Here, the coupler 155 obtains information such as the strength of the wireless signal output by the front-end module 151 and feeds it back to the signal processing circuit unit 13. The signal processing circuit unit 13 refers to the feedback and controls the strength and the like of the wireless signal to be generated.

On the other hand, the signal filter 156 causes a wireless signal in the 5 GHzHigh band to selectively pass therethrough from the wireless signal output by the front-end module 151 and outputs the same to the antenna 17b via the switch module 18c, and the antenna 17b radiates the wireless signal. Then, the wireless signal reaches the wireless communication client C5 communicating in the 5 GHzHigh band.

Under the setting of Setting b, the wireless signal of the wireless communication client C6 communicating in the relatively low frequency band (5 GHzLow) of the 5 GHz band that reaches the antenna 17a is distributed by the diplexer 16, and input to the third signal processing module 15c and the fourth signal processing module 15d. Here, since the third signal processing module 15a processes signals in the 2.4 GHz band, signals in the 5 GHz band are not filtered and handled.

In Setting b, since the front-end module 151 is connected to the coupler 155 via the signal filter 157 inside the fourth signal processing module 15d by the switch module 18b, the wireless signal input to the fourth signal processing module 15d is input to the signal filter 157 via the coupler 155 of the fourth signal processing module 15d.

The signal filter 157 passes a signal in the 5 GHzLow frequency band from the input wireless signal and outputs the signal to the front-end module 151. The front-end module 151 of the fourth signal processing module 15d performs predetermined processing such as filtering on the wireless signal and outputs the wireless signal to the signal processing circuit unit 19.

The signal processing circuit unit 19 demodulates the wireless signal of the wireless communication client C6 communicating in the 5 GHzLow band included in the 5 GHz band, and outputs information obtained by the demodulation to the controller 11. In this way, the controller 11 obtains information transmitted by the wireless communication client C6 communicating in the 5 GHzLow band.

On the other hand, the controller 11 outputs information, which is to be transmitted to the wireless communication client C6 communicating in the 5 GHzLow band, to the signal processing circuit unit 19.

The signal processing circuit unit 19 accepts communication target information input from the controller 11, modulates the information into a wireless signal, and generates a wireless signal in the corresponding frequency band (here, 5 GHz band). The signal processing circuit unit 19 outputs the generated wireless signal to the fourth signal processing module 15d.

The front-end module 151 of the fourth signal processing module 15d performs predetermined processing such as filtering on the wireless signal. Here, since the front-end module 151 is connected to the coupler 155 via the signal filter 157 inside the fourth signal processing module 15d, the signal filter 157 passes a signal in a 5 GHzLow band from the wireless signal processed by the front-end module 151 and outputs the signal to the diplexer 16 via the coupler 155. Here, the coupler 155 obtains information such as the strength of the wireless signal output via the signal filter 157 by the front-end module 151 and feeds it back to the signal processing circuit unit 19. The signal processing circuit unit 19 refers to the feedback and controls the strength and the like of the wireless signal to be generated.

The diplexer 16 radiates the wireless signal output by the fourth signal processing module 15d via the antenna 17a. Then, the wireless signal reaches the wireless communication client C6 communicating in the 5 GHzLow band.

On the other hand, at this time, the wireless signal of the wireless communication client C2 communicating in the 2.4 GHz band is distributed by the diplexer 16 via the antenna 17a and input to the third signal processing module 15c and the fourth signal processing module 15d, as in the example described above. Here, since the fourth signal processing module 15d processes signals in the 5 GHzLow band, signals in the 2.4 GHz band are not filtered and handled.

The wireless signal input to the third signal processing module 15c is input to the front-end module 151 via the coupler 155 of the third signal processing module 15c. The front-end module 151 of the third signal processing module 15c performs predetermined processing such as filtering on the wireless signal and outputs the wireless signal to the signal processing circuit unit 14.

The signal processing circuit unit 14 demodulates the wireless signal of the wireless communication client C2 communicating in the 2.4 GHz band and outputs information obtained by the demodulation to the controller 11. In this way, the controller 11 obtains the information transmitted by the wireless communication client C2 communicating in the 2.4 GHz band. On the other hand, the controller 11 outputs information, which is to be transmitted to the wireless communication client C2 communicating in the 2.4 GHz band, to the signal processing circuit unit 14.

The signal processing circuit unit 14 accepts communication target information input from the controller 11, modulates the information into a wireless signal, and generates a wireless signal in the corresponding frequency band (here, 2.4 GHz band). The signal processing circuit unit 14 outputs the generated wireless signal to the third signal processing module 15c.

Then, the front-end module 151 of the third signal processing module 15c performs predetermined processing such as filtering on the wireless signal and outputs the processed wireless signal to the diplexer 16 via the coupler 155. Here, the coupler 155 obtains information such as the strength of the wireless signal output by the front-end module 151 and feeds it back to the signal processing circuit unit 14. The signal processing circuit unit 14 refers to the feedback and controls the strength and the like of the wireless signal to be generated.

The diplexer 16 radiates the wireless signal output by the third signal processing module 15c via the antenna 17a. Then, the wireless signal reaches the wireless communication client C2 communicating in the 2.4 GHz band.

In this way, according to the example of the present embodiment, in the tri-band, either an example in which the 6 GHz band is used or an example in which the 5 GHz band is divided into a relatively high frequency band and a low frequency band and used can be selected. Therefore, while corresponding to wireless communication in multiple frequency bands, the relatively expensive signal processing circuit unit is used in a smaller number than the number of frequency bands intended to correspond and switched and connected to the signal processing module corresponding to each frequency band, making it possible to suppress an increase in device cost.

### Modified Embodiments

Note that in the description so far, for example, the tri-band configuration corresponds to:
(Setting a) 2.4 GHz+5 GHz+6 GHz, or
(Setting b) 2.4 GHz+5 GHzLow+5 GHzHigh
(here, the “+” notation means that, when A+B+C is written, it corresponds to wireless communication in each frequency band of A, B, and C.) However, the present embodiment is not limited thereto.

For example, a channel in the 6 GHz band may be limited to a band (a band of 5.295 GHz to 6.425 GHZ, so-called 6L band) equivalent to UNII-5.

In addition, the frequency bands to which the signal processing circuit units 13, 14, 19, and the like correspond may be changed to correspond to, for example, the bands of UNII-5, 6, 7, and 8 specified in UNII (Unlicensed National Information Infrastructure). In this example, for example:
(Setting a) 5 GHz+UNII-5+UNII-6, or
(Setting a′) 5 GHz+UNII-5+UNII-6, 7, or
(Setting a″) 5 GHz+UNII-5+UNII-6, 7, 8, and
(Setting b) 5 GHzLow+5 GHzHigh+6 GHz (equivalent to UNII-5)
   may be switched. In this example, it is contemplated that while the bands up to UNII-5 are mainly used, Setting b is set, and then any one (corresponding to multiple 6 GHz bands) of Settings a, a′ and a″ is set when wireless communication clients (terminals) corresponding to UNII-6, 7, and 8 are distributed.

The present embodiments described above are summarized as follows.

A wireless communication device of the present embodiments includes: signal processing circuits configured to generate or demodulate wireless signals in a first frequency band and a second frequency band, wherein the first frequency band is different than the second frequency band; first and second signal processing module circuits communicably coupled to the signal processing circuits, the first and second signal processing module circuits configured to respectively process the wireless signals in the first frequency band and the second frequency band generated or demodulated by the signal processing circuits; and a switch module circuit configured to selectively connect the signal processing circuits with any one of the first and second signal processing module circuits.

This makes it possible to switch and use a high-cost element as signal processing circuits in multiple bands, thereby suppressing an increase in device cost while corresponding to wireless communication in multiple frequency bands.

In addition, the first and second signal processing module circuits may include signal filter circuits configured to pass the wireless signals in the first frequency band and the second frequency band, respectively.

The first and second signal processing module circuits may include at least signal filter circuits configured to filter the wireless signals in the first frequency band and the second frequency band and coupler circuits configured to detect signal strengths of the wireless signals in the first frequency band and the second frequency band, respectively.

The wireless communication device may further include an antenna-side switch module circuit configured to selectively connect any one of the first and second signal processing module circuits to an antenna.

The first and second signal processing module circuits may be connected to first and second antennas, respectively.

The first and second signal processing module circuits may be included in a set of signal processing module circuits, in which the signal processing circuits may include a first-type signal processing circuit, in which the signal processing circuits may include second-type signal processing circuits each connected to a single signal processing module circuits, included in the set of signal processing module circuits, the second-type signal processing circuits configured to generate or demodulate wireless signals in different frequency bands, respectively, the signal processing module circuits configured to respectively process the wireless signals in the different frequency bands generated or demodulated by the second-type signal processing circuits, and in which the wireless communication device may further include a signal synthesis module circuit connected to an antenna, the signal synthesis module circuit configured to synthesize or split one or more wireless signals to be input and output to and from the second-type signal processing circuits.

The first and second signal processing module circuits may be included in a set of signal processing module circuits, in which the signal processing circuits may include a first-type signal processing circuit, in which the signal processing circuits include second-type signal processing circuits each connected to a single signal processing module circuits, included in the set of signal processing module circuits, the second-type signal processing circuits configured to generate or demodulate wireless signals in different frequency bands, respectively, the signal processing module circuits configured to respectively process the wireless signals in the different frequency bands generated or demodulated by the second-type signal processing circuits, and in which the signal processing module circuits connected to the second-type signal processing circuits each may include: a signal filter circuit configured to filter a wireless signal in a predetermined frequency band, and a pair of filter switch module circuits configured to pass the wireless signal in the predetermined frequency band via the signal filter circuit or via a path bypassing the signal filter circuit.

The switch module circuit and the pair of filter switch module circuits may be set to operate in cooperation with each other.

The the first and second signal processing module circuits may be included in a set of signal processing module circuits, in which the signal processing circuits may include a first-type signal processing circuit, in which the signal processing circuits may include a second-type signal processing circuit connected to a single signal processing module circuit, included in the set of signal processing module circuits, the second-type signal processing circuit configured to generate or demodulate a wireless signal in a predetermined frequency band, the single signal processing module circuit configured to process the wireless signal in the predetermined frequency band generated or demodulated by the second-type signal processing circuit, and in which the wireless communication device may further include a signal synthesis module circuit connected to an antenna, the signal synthesis module circuit configured to synthesize or split one or more wireless signals to be input and output to and from the second-type signal processing circuit.

The signal processing circuits may include a 6 GHz signal processing circuit configured to generate or demodulate wireless signals in a relatively high frequency band of a 5 GHz frequency band and a 6 GHz frequency band, in which the signal processing circuits may include a 5 GHz signal processing circuit configured to generate or demodulate a wireless signal in a relatively low frequency band of the 5 GHz band, and in which the 6 GHz signal processing circuit may be connected to the first and second signal processing module circuits configured to respectively process the wireless signals generated or demodulated by the 6 GHz signal processing circuit.

The signal processing circuits may include a first signal processing circuit configured to generate or demodulate wireless signals in a relatively high frequency band of a 5 GHz frequency band and a UNII (Unlicensed National Information Infrastructure)-6 frequency band, in which the signal processing circuits may include a second signal processing circuit configured to generate or demodulate a wireless signal in a UNII-5 frequency band and a third signal processing circuit configured to generate or demodulate a wireless signal in a 5 GHz frequency band, and in which the first signal processing circuit may be connected to the first and second signal processing module circuits configured to respectively process the wireless signals generated or demodulated by the first signal processing circuit.

The signal processing circuits may include a first signal processing circuit configured to generate or demodulate wireless signals in a relatively high frequency band of a 5 GHz frequency band and a frequency band higher than a UNII (Unlicensed National Information Infrastructure)-6 frequency band, in which the signal processing circuits may include a second signal processing circuit configured to generate or demodulate a wireless signal in a UNII-5 frequency band and a third signal processing circuit configured to generate or demodulate a wireless signal in a 5 GHz frequency band, and in which the first signal processing circuit may be connected to the first and second signal processing module circuits configured to respectively process the wireless signals generated or demodulated by the first signal processing circuit.

A control method of the present embodiment is executed by a central processing unit (CPU) of a wireless communication device. The CPU is configured to: generate or demodulate, using signal processing circuits of the wireless communication device, wireless signals in a first frequency band and a second frequency band, wherein the first frequency band is different than the second frequency band; respectively process, using first and second signal processing modules of the wireless communication device that are communicably coupled to the signal processing circuits, wireless signals in the first frequency band and the second frequency band generated or demodulated by the signal processing circuits; and selectively connect, using a switch module circuit of the wireless communication device that is communicably coupled to the signal processing circuit and the first and second signal processing module circuits, the signal processing circuit with any one of the first and second signal processing module circuits.

According to the present disclosure, it is possible to suppress an increase in device cost while corresponding to wireless communication in multiple frequency bands.

1. A wireless communication device, comprising:
signal processing circuits configured to generate or demodulate wireless signals in a first frequency band and a second frequency band, wherein the first frequency band is different than the second frequency band;
first and second signal processing module circuits communicably coupled to the signal processing circuits, the first and second signal processing module circuits configured to respectively process the wireless signals in the first frequency band and the second frequency band generated or demodulated by the signal processing circuits; and
a switch module circuit configured to selectively connect the signal processing circuits with any one of the first and second signal processing module circuits.

2. The wireless communication device according to claim 1, wherein the first and second signal processing module circuits comprise signal filter circuits configured to pass the wireless signals in the first frequency band and the second frequency band, respectively.

3. The wireless communication device according to claim 1, wherein the first and second signal processing module circuits comprise at least signal filter circuits configured to filter the wireless signals in the first frequency band and the second frequency band and coupler circuits configured to detect signal strengths of the wireless signals in the first frequency band and the second frequency band, respectively.

4. The wireless communication device according to claim 1, further comprising an antenna-side switch module circuit configured to selectively connect any one of the first and second signal processing module circuits to an antenna.

5. The wireless communication device according to claim 1, wherein the first and second signal processing module circuits are connected to first and second antennas, respectively.

6. The wireless communication device according to claim 1, wherein the first and second signal processing module circuits are included in a set of signal processing module circuits, wherein the signal processing circuits include a first-type signal processing circuit, wherein the signal processing circuits include second-type signal processing circuits each connected to a single signal processing module circuits, included in the set of signal processing module circuits, the second-type signal processing circuits configured to generate or demodulate wireless signals in different frequency bands, respectively, the signal processing module circuits configured to respectively process the wireless signals in the different frequency bands generated or demodulated by the second-type signal processing circuits, and
wherein the wireless communication device further comprises a signal synthesis module circuit connected to an antenna, the signal synthesis module circuit configured to synthesize or split one or more wireless signals to be input and output to and from the second-type signal processing circuits.

7. The wireless communication device according to claim 1, wherein the first and second signal processing module circuits are included in a set of signal processing module circuits, wherein the signal processing circuits include a first-type signal processing circuit, wherein the signal processing circuits include second-type signal processing circuits each connected to a single signal processing module circuits, included in the set of signal processing module circuits, the second-type signal processing circuits configured to generate or demodulate wireless signals in different frequency bands, respectively, the signal processing module circuits configured to respectively process the wireless signals in the different frequency bands generated or demodulated by the second-type signal processing circuits, and
wherein the signal processing module circuits connected to the second-type signal processing circuits each comprise:
a signal filter circuit configured to filter a wireless signal in a predetermined frequency band, and
a pair of filter switch module circuits configured to pass the wireless signal in the predetermined frequency band via the signal filter circuit or via a path bypassing the signal filter circuit.

8. The wireless communication device according to claim 7, wherein the switch module circuit and the pair of filter switch module circuits are set to operate in cooperation with each other.

9. The wireless communication device according to claim 1, wherein the first and second signal processing module circuits are included in a set of signal processing module circuits, wherein the signal processing circuits include a first-type signal processing circuit, wherein the signal processing circuits include a second-type signal processing circuit connected to a single signal processing module circuit, included in the set of signal processing module circuits, the second-type signal processing circuit configured to generate or demodulate a wireless signal in a predetermined frequency band, the single signal processing module circuit configured to process the wireless signal in the predetermined frequency band generated or demodulated by the second-type signal processing circuit, and
wherein the wireless communication device further comprises a signal synthesis module circuit connected to an antenna, the signal synthesis module circuit configured to synthesize or split one or more wireless signals to be input and output to and from the second-type signal processing circuit.

10. The wireless communication device according to claim 1, wherein the signal processing circuits include a 6 GHz signal processing circuit configured to generate or demodulate wireless signals in a relatively high frequency band of a 5 GHz frequency band and a 6 GHz frequency band, wherein the signal processing circuits include a 5 GHz signal processing circuit configured to generate or demodulate a wireless signal in a relatively low frequency band of the 5 GHz band, and wherein the 6 GHz signal processing circuit is connected to the first and second signal processing module circuits configured to respectively process the wireless signals generated or demodulated by the 6 GHz signal processing circuit.

11. The wireless communication device according to claim 1, wherein the signal processing circuits include a first signal processing circuit configured to generate or demodulate wireless signals in a relatively high frequency band of a 5 GHz frequency band and a UNII (Unlicensed National Information Infrastructure)-6 frequency band, wherein the signal processing circuits include a second signal processing circuit configured to generate or demodulate a wireless signal in a UNII-5 frequency band and a third signal processing circuit configured to generate or demodulate a wireless signal in a 5 GHz frequency band, and wherein the first signal processing circuit is connected to the first and second signal processing module circuits configured to respectively process the wireless signals generated or demodulated by the first signal processing circuit.

12. The wireless communication device according to claim 1, wherein the signal processing circuits include a first signal processing circuit configured to generate or demodulate wireless signals in a relatively high frequency band of a 5 GHz frequency band and a frequency band higher than a UNII (Unlicensed National Information Infrastructure)-6 frequency band, wherein the signal processing circuits include a second signal processing circuit configured to generate or demodulate a wireless signal in a UNII-5 frequency band and a third signal processing circuit configured to generate or demodulate a wireless signal in a 5 GHz frequency band, and wherein the first signal processing circuit is connected to the first and second signal processing module circuits configured to respectively process the wireless signals generated or demodulated by the first signal processing circuit.

13. A control method executed by a central processing unit (CPU) of a wireless communication device, the CPU being configured to:
generate or demodulate, using signal processing circuits of the wireless communication device, wireless signals in a first frequency band and a second frequency band, wherein the first frequency band is different than the second frequency band;
respectively process, using first and second signal processing modules of the wireless communication device that are communicably coupled to the signal processing circuits, wireless signals in the first frequency band and the second frequency band generated or demodulated by the signal processing circuits; and
selectively connect, using a switch module circuit of the wireless communication device that is communicably coupled to the signal processing circuit and the first and second signal processing module circuits, the signal processing circuit with any one of the first and second signal processing module circuits.
